(19) United States
(12) Patent Application Publication
(10) Pub. No.: US 2010/0190515 A1
(43) Pub. Date: Jul. 29, 2010

(54) SMS DEVICE MANAGER

(75) Inventors: Matthew Raghu Sharma, Minneapolis, MN (US); Kevin Sanh Hong, St. Paul, MN (US)

Correspondence Address: SCHWEGMAN, LUNDBERG & WOESSNER, P.A., P.O. BOX 2938, MINNEAPOLIS, MN, 55402, US

(73) Assignee: MULTITECH SYSTEMS, INC., MOUNDS VIEW, MN (US)

(21) Appl. No.: 12/361,908

(22) Filed: Jan. 29, 2009

(51) Int. Cl. H04W 4/00; H04L 12/56

(52) U.S. Cl. 455/466; 370/389

(57) ABSTRACT

A system includes a first device, a plurality of remote devices, and a mobile device. The first device is configured to couple to a first communication network. The plurality of remote devices are configured to couple to the first communication network. The mobile device is configured to couple to the first device by a second communication network. The first device is configured to communicate a finding to the mobile device, the finding corresponding to at least one remote device.

### CROSS-REFERENCE TO RELATED PATENT DOCUMENTS

This document is related to U.S. patent application Ser. No. 12/239,387, MESSAGE SERVER, filed Sep. 26, 2008, which is incorporated herein by reference.

### BACKGROUND

A text message can be wirelessly communicated using a service sometimes referred to as short message service (SMS). One example of SMS messaging includes communicating a short text string from a first mobile handheld telephone to a second mobile handheld telephone.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1, includes a system diagram according to one example.

FIG. 2 includes a flow chart of a method according to one example.

FIG. 3 includes a flow chart of a method according to one example.

### DETAILED DESCRIPTION

The present subject matter enables device monitoring using short message service (SMS). In one example, a first device is coupled to an IP network and is configured to monitor a plurality of devices such as servers and sensors.

As used herein, the term SMS includes a variety of messaging services, including Multimedia Messaging Service (MMS) and Enhanced SMS (also known as ESMS, EMS, SMS 2, or Instant SMS). Multimedia Messaging Service enables messages having longer text, graphics, photos, audio or video clips. Enhanced SMS refers to a service that supports a variety of special text formatting, animations, pictures, icons, and audio effects. Other messaging services can also be configured for use with the present subject matter.

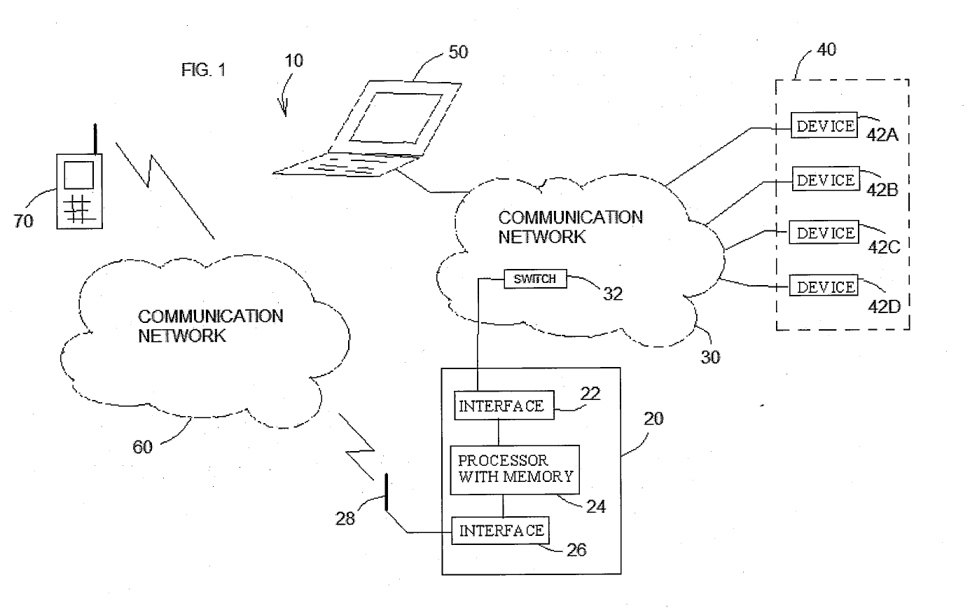

FIG. 1 illustrates a diagram of system 10 according to one example. System 10 includes first device 20 and monitored devices 42A, 42B, 42C, and 42D (collectively referred to as plurality 40) coupled by communication network 30. In addition, first device 20 and mobile device 70 are coupled by communication network 60.

In the example shown, first device 20 includes interface 22, processor 24, and interface 26. Interface 22 couples with communication network 30 by a wired link (such as an Ethernet link) or by a wireless link. Interface 22 can include hardware, firmware, or software and in one example, includes a module to communicate with switch 32 of communication network 30. Processor 24 can include a memory having instructions stored thereon for executing an algorithm according to an example described herein. Processor 24 can be configured to implement an algorithm that provides security functions. For example, processor 24 can implement an encryption algorithm or implement an authentication algorithm. Interface 26 denotes a module (hardware, firmware, or software) for exchanging messages with communication network 60. In one example, interface 26 includes a radio frequency (RF) transceiver for-communicating using a cellular communication protocol. In the example illustrated, interface 26 is coupled to RF antenna 28. Antenna 28 is configured to communicate wirelessly using communication network 60.

In one example, interface 26 includes a modem for communicating with communication network 60. The modem can include a Quad-band GSM 850/900/1800/1900 MHz. In one example, interface 26 is configured to receive a Subscriber Identity Module (SIM) card. The SIM card enables communicating using a General Packet Radio Service (GPRS) network. A SIM card can also enable communicating via SMS (including MMS and ESMS) and may store messages and phone book contacts. Interface 26 can include a connector for coupling with a radio frequency (RF) antenna.

The example illustrated includes monitored devices 42A, 42B, 42C, and 42D however any number of devices is contemplated. Monitored devices 42A, 42B, 42C, and 42D, and for descriptive purposes only, are shown grouped within a dashed line corresponding to plurality 40. In particular, the monitored devices can be distributed over any size region or geographical area. The plurality 40 can include various devices including a stationary device, a mobile device, a portable device, or other hardware configured to communicate using an IP protocol. In one example, a monitored device includes a server or other processor-based equipment.

Communication network 30 can include a local area network (LAN) such as an Ethernet. Communication network 30 can include a server, a router, a gateway, a switch, a workstation, and other wired or wireless components configured for exchanging packetized data using an internet protocol. In various examples, communication network 30 is configured to communicate using a protocol such as Internet Protocol (IP), Domain Name Server (DNS), Internet Control Message Protocol (ICMP), Hypertext Transfer Protocol (HTTP), HTTP over Secure Socket Layer (HTTPS), telnet, Secure Shell (SSH), Simple Mail Transfer Protocol (SMTP), Post Office Protocol (POP3), Simple Network Management Protocol (SNMP) trap, and others. In one example, communication network 30 includes a wide area network (WAN) such as the internet.

In one example, communication network 30 is compatible with 10/100BaseT communication protocol. As such, interface 22 includes an RJ-45 connector for coupling first device 20 with communication network 30.

Computer 50 can include a workstation, a server, a laptop, a desktop, or other processor-based device for communicating using communication network 30. In one example, computer 50 includes programming to operate a web browser in order to interface with communication network 30.

In one example, communication network 60 includes a wide area network (WAN), such as a cellular network configured for cellular communications. As such, first device 20 and mobile device 70 can communicate wirelessly using SMS messages. Either or both of communication network 30 and communication network 60 can include a data packet switched network.

In various examples, communication network 60 can communicate using Evolution-Data Optimized (EV-DO), GPRS, High-Speed Packet Access (HSPA), Code Division Multiple Access (CDMA), Long Term Evolution (LTE), Worldwide Interoperability for Microwave Access (WiMax), and Enhanced Data Rates for GSM Evolution (EDGE).

Mobile device 70 can include a processor-based, portable, handheld device, and in the example illustrated, includes a display and a user-operable keyboard. In various examples, mobile device 70 includes a cellular telephone, a laptop computer, or a personal digital assistant (PDA). Mobility denotes the ability to change location whereas portability includes mobility and further denotes the ability to be carried about by hand.

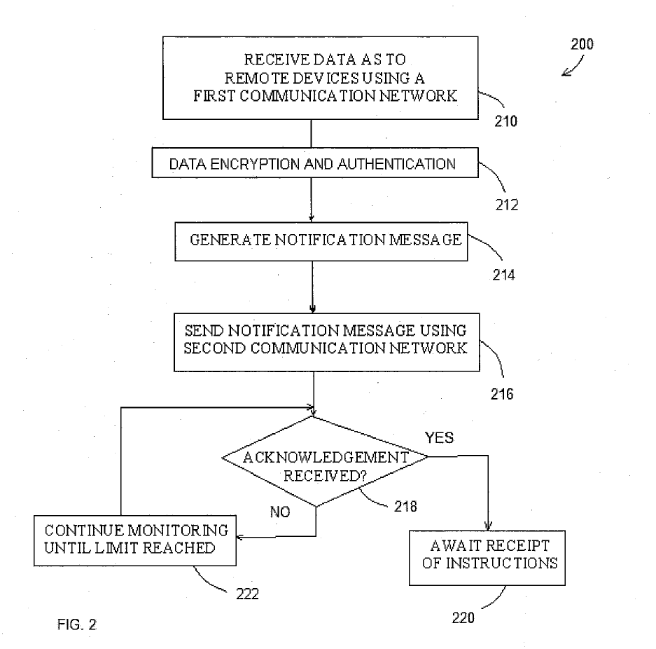

FIG. 2 includes a flow chart of method 200 according to one example. Method 200 can be implemented by system 10. At 210, method 200 includes receiving data as to one or more remote devices (such as devices 42A, 42B, 42C, and 42D) using a first communication network (such as communication network 30). The received data can include, for example, information as to the current status of a remote device, such as device 42A, or performance data, diagnostic data, or other information in order to allow monitoring, managing, or controlling of device 42A. At 212, method 200 includes executing a routine that provides data encryption and authentication. In one example, this can include implementing a security and data integrity scheme such as Internet Protocol Security (IPsec). Internet Protocol Security refers to a suite of protocols for securing Internet Protocol (IP) communications by authenticating and encrypting IP packets of a data stream. In various examples, this can include implementing a security and data integrity scheme such as Hypertext Transfer Protocol over Secure Sockets Layer (HTTPS), an extension of HTTP, or implementing a security scheme based on Transport Layer Security (TLS), Secure Sockets Layer (SSL), or implementing some other security scheme.

At 214, method 200 includes generating a notification message. In one example, the notification message is generated by processor 24 and the content of the message denotes a detected condition or event as to a particular remote device. At 216, method 200 includes sending the notification message using communication network 60. In one example, this includes transmitting a cellular message using SMS (or MMS and ESMS).

At 218, method 200 includes a query as to receipt of acknowledgement of the notification message. The acknowledgement can be received using communication network 60 and in one example, includes a reply SMS message. The acknowledgement can be manually generated by a user or can be automatically generated based on a detected receipt at mobile device 70.

If the result of the query at 218 is affirmative, then method 200 includes, at 220, awaiting receipt of further instructions. For example, a user can enter data via mobile device 70 to call for reconfiguring or re-booting of remote device 42A. If the result of the query at 218 is negative, then method 200 includes, at 222, continuing monitoring for acknowledgement until a limit is reached. The limit can be a specified number of failed attempts, a period of time, or other predetermined measure.

Variations of method 200 are also contemplated, including for example, performing data encryption or authentication in conjunction with other routines illustrated in the figure. For example, data encryption and authentication 212 is shown following receipt of data, however, data encryption and authentication can be implemented at other locations, including following sending of the notification message at 216 or following await receipt of instructions at 220. In addition, data encryption can be performed at a first portion of method 200 and authentication can be performed at a second, and different, portion of method 200.

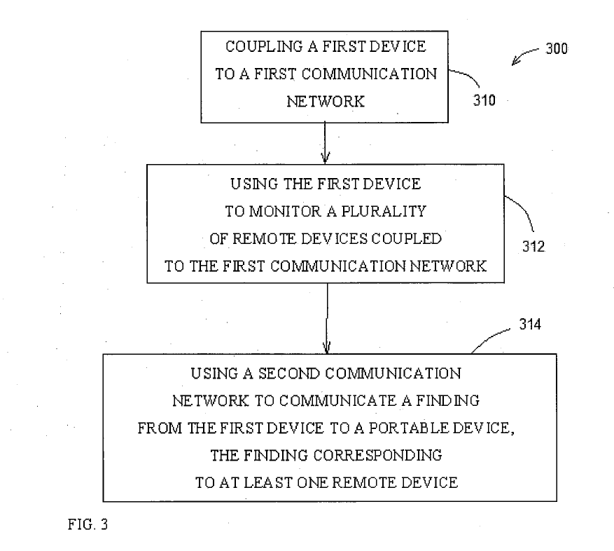

FIG. 3 includes a flow chart of method 300 according to one example. Method 300 can be implemented using system 10. At 310, method 300 includes coupling first device 20 to communication network 30. This can include a wired connection using an RJ-45 connector, establishing an electrical connection with switch 32, or otherwise coupling first device 20 and communication network 30. In one example, first device 20 is coupled to communication network 30 by a wireless link.

At 312, method 300 includes using first device 20 to monitor a plurality of remote devices, such as devices 42A, 42B, 42C, and 42D coupled to communication network 30. Monitoring can include detecting events or conditions as well as controlling operation of a remote device. At 314, method 300 includes using a second communication network (such as communication network 60) to communicate a finding from first device 20 to a portable device (such as mobile device 70). The finding corresponds to at least one remote device and can represent, for example, a status indication, a detected event, or other reported data that correlates to the monitored device.

Variations of method 300 are also contemplated, including for example, performing data encryption or authentication in conjunction with the various routines illustrated in the figure. For example, data encryption and authentication can be implemented before or after using the first device to monitor, as shown at 312. In addition, data encryption can be performed at a first portion of method 300 and authentication can be performed at a second, and different, portion of method 300.

Other methods, including various combinations of those described herein are also contemplated.

For example, first device 20 can be configured to ping, scan, or connect with the monitored devices 42A, 42B, 42C, and 42D. Any of monitored devices 42A, 42B, 42C, and 42D can be activated by an instruction or message from first device 20. If a monitored device fails to reply or fails to establish a communication link after a number of attempts, then a notification message is generated. The notification message is sent from first device 20 using communication network 60. The notification message can be sent as an SMS message to mobile device 70 or can be sent to any number of selected cellular recipients. In one example, the first device 20 continues to send the SMS notification message until an acknowledgment or confirmation reply is received.

In one example, first device 20 is configured to enable mobile device 70 to control the monitored device, such as device 42A. For example, an end user of mobile device 70 can actively send an instruction to monitored device 42A to enable control of monitored device 42A. An end user can communicate with the monitored device using SMS. The communication can be single-directional (notification only) or bi-directional (query and response). In one example, first device 20 transmits an instruction to a monitored device, such as device 42A, wherein the instruction is based on the received SMS message and wherein the particular monitored device is selected based on an SMS message. A first SMS message can indicate, for example, that monitored device 42A is overburdened with a work load and a mobile device 70 can then be used to increase loading of monitored device 42B.

The SMS message received at first device 20 can specify a particular monitored device and can include an instruction to cause the monitored device to be, for example, remotely rebooted, powered off, scanned, diagnosed, or re-configured. In addition, first device 20 can prompt the user for responses that are then compiled and used to generate an instruction for a particular monitored device. The prompts (or queries) and responses can be exchanged using SMS. In one example, first device 20 provides the user with various SMS command options.

In one example, the SMS messages between first device 20 and mobile device 70 (which can be carried by the authorized user) are encrypted or otherwise encoded to maintain security or to authenticate a source. Data encryption can be implemented for a message transmitted from a monitored device, the first device, and the mobile device. In addition, authentication can be implemented for a message transmitted from a monitored device, the first device, and the mobile device.

In one example, a web browser can be used to configure and manage first device 20. The web browser can operate on computer 50, for example, coupled to communication network 30 that may be in common with first device 20 or it can be directly coupled to first device 20 by a wired or wireless link.

In one example, first device 20 communicates with a particular monitored device using a communication protocol such as ICMP, HTTP, HTTPS, telnet, SSH, SMTP, POP3, SNMP trap, or others.

In one example, a remote SMS device can be monitored using an SMS message and the message can be forwarded using a local application server.

In one example, the message communicated from monitored device 42A, for example, to first device 20 denotes an alarm condition or other such message indicating a level of urgency. Upon receiving such a message, first device 20 is configured to continuously or repeatedly send an SMS notification message to a specified administrator, such as mobile device 50, until receipt is acknowledged. The acknowledgement can be a reply SMS message.

In one example, first device 20 is configured to change the number of monitored devices in response to a received SMS message. For example, an SMS message can call for adding or removing a device to the plurality of monitored devices. A change in the number of monitored devices can be made using an SMS message or by using a web browser in communication with the first device.

In one example, first device 20 includes a wireless modem having a GPRS or HSPA data connection to enable an administrator to remotely access a local network using a wireless connection. A number of other administrative functions can also be executed by various examples of the present subject matter. For example, an administrator can send an SMS message to check the health or status of a specific device, such as device 42A. An administrator can send an SMS message to reboot or restart a specific device. This can be particularly helpful in the event of a device lock-up. In addition, an administrator can measure or report latency for a specific device.

One example of the present subject matter allows monitoring of up to 200 remote devices, however, numbers greater or less than this number can also be monitored. First device 20 can be configured to send a status report via electronic mail (e-mail) from time to time. The e-mail report can be sent periodically or on a scheduled basis to a specified destination. First device 20 can be configured to both receive an e-mail message and send an e-mail message.

Mobile device 70 can communicate using SMS with the plurality 40 of remote devices. More than one mobile device 70 can be used, with each mobile device having a specific telephone number. The various telephone numbers can be entered using a network connected computer or by an incoming call to first device 20. A memory of first device 20 includes an address book to store contact information. In one example, the contact information can be grouped and rights and authorizations for each contact assigned according to a specified schedule.

The present subject matter can be used in an information technology (IT) environment, a medical environment (such as a medical facility) or in a residential application (such as for house arrest or in a home-care setting).

One example includes a system configured as a 1-port SMS platform. Hardware, firmware or software can be configured to implement various elements as described in this document.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A system comprising:
a first device configured to couple to a first communication network;
a plurality of remote devices configured to couple to the first communication network; and
a mobile device configured to couple to the first device by a second communication network, the first device configured to communicate a finding to the mobile device, the finding corresponding to at least one remote device.

2. The system of claim 1 wherein the first communication network includes an IP based network.

3. The system of claim 1 wherein the first communication network includes at least one of a wide area network and a local area network.

4. The system of claim 1 wherein the first device is configured to communicate using an Internet Protocol (IP).

5. The system of claim 4 wherein the Internet Protocol includes at least one of Domain Name Server (DNS), Internet Control Message Protocol (ICMP), Hypertext Transfer Protocol (HTTP), HTTP over Secure Socket Layer (HTTPS), telnet, Secure Shell (SSH), Simple Mail Transfer Protocol (SMTP), Post Office Protocol (POP3), and Simple Network Management Protocol (SNMP) trap.

6. The system of claim 1 wherein the second communication network is configured to communicate a short message service (SMS) message.

7. The system of claim 1 wherein the second communication network includes a data packet switched network.

8. The system of claim 1 wherein the first device is configured to monitor for an acknowledgement of receipt from the mobile device.

9. The system of claim 1 wherein the first device is configured to communicate using a cellular network.

10. The system of claim 9 wherein the cellular network includes at least one of Evolution-Data Optimized (EV-DO), General Packet Radio Service (GPRS), High-Speed Packet Access (HSPA), Code Division Multiple Access (CDMA), Long Term Evolution (LTE), Worldwide Interoperability for Microwave Access (WiMax), and Enhanced Data Rates for GSM Evolution (EDGE).

11. The system of claim 1 wherein the first device is configured to communicate with a web-based browser.

12. The system of claim 1 wherein the first device is configured to communicate using an e-mail message.

13. The system of claim 1 wherein the mobile device is configured to receive a user-entered selection.

14. The system of claim 13 wherein the first device is configured to generate an instruction for at least one remote device using the user-entered selection.

15. A device comprising:
a first interface configured to couple with a plurality of remote devices using a first communication network;
a processor coupled to the first interface and configured to generate a finding corresponding to at least one remote device of the plurality of remote devices; and
a second interface coupled to the processor and configured to communicate with a mobile device using a second communication network, the second communication network compatible with a short message service (SMS).

16. The device of claim 15 wherein the first interface is configured to communicate using an Internet Protocol (IP).

17. The device of claim 16 wherein the Internet Protocol includes at least one of Internet Control Message Protocol (ICMP), Hypertext Transfer Protocol (HTTP), HTTP over Secure Socket Layer (HTTPS), telnet, Secure Shell (SSH), Simple Mail Transfer Protocol (SMTP), Post Office Protocol (POP3), and Simple Network Management Protocol (SNMP) trap.

18. The device of claim 15 wherein the processor is configured to monitor for an acknowledgement of receipt of a message.

19. The device of claim 15 wherein the processor is configured to communicate using a cellular network.

20. The device of claim 19 wherein the cellular network includes at least one of Evolution-Data Optimized (EV-DO), General Packet Radio Service (GPRS), High-Speed Packet Access (HSPA), Code Division Multiple Access (CDMA), Long Term Evolution (LTE), Worldwide Interoperability for Microwave Access (WiMax), and Enhanced Data Rates for GSM Evolution (EDGE).

21. The device of claim 15 wherein the processor is configured to communicate using an e-mail message.

22. The device of claim 15 wherein the processor is configured to receive a user-entered selection using the second interface.

23. The device of claim 22 wherein the processor is configured to generate. an instruction for at least one remote device using the user-entered selection.

24. A method comprising:
coupling a first device to a first communication network;
using the first device to monitor a plurality of remote devices coupled to the first communication network; and
using a second communication network to communicate a finding from the first device to a mobile device, the finding corresponding to at least one remote device.

25. The method of claim 24 wherein using the first device to monitor includes monitoring using an Internet Protocol (IP).

26. The method of claim 25 wherein the Internet Protocol includes at least one of Internet Control Message Protocol (ICMP), Hypertext Transfer Protocol (HTTP), HTTP over Secure Socket Layer (HTTPS), telnet, Secure Shell (SSH), Simple Mail Transfer Protocol (SMTP), Post Office Protocol (POP3), and Simple Network Management Protocol (SNMP) trap.

27. The method of claim 24 wherein using the second communication network to communicate the finding includes communicating a short message service (SMS) message.

28. The method of claim 24 wherein using the second communication network includes using a data packet switched network.

29. The method of claim 24 wherein using the second communication network to communicate the finding includes using the first device to monitor for an acknowledgement of receipt from the mobile device.

30. The method of claim 24 further including communicating with the first device using a cellular network.

31. The method of claim 30 wherein the cellular network includes at least one of Evolution-Data Optimized (EV-DO), General Packet Radio Service (GPRS), High-Speed Packet Access (HSPA), Code Division Multiple Access (CDMA), Long Term Evolution (LTE), Worldwide Interoperability for Microwave Access (WiMax), and Enhanced Data Rates for GSM Evolution (EDGE).

32. The method of claim 24 further including using a web-based browser to communicate with the first device.

33. The method of claim 24 wherein communicating the finding includes sending an e-mail message.

34. The method of claim 24 further including:
receiving a user-entered selection at the mobile device;
generating an instruction for at least one remote device using the user-entered selection; and
communicating the instruction using the first communication network.

35. The method of claim 34 wherein the user-entered selection includes identification of the at least one remote device.

36. The method of claim 24 further including implementing data encryption for a message sent from at least one of a remote device selected from the plurality of remote devices, the first device, and the mobile device.

37. The method of claim 24 further including implementing authentication for a message sent from at least one of a remote device selected from the plurality of remote devices, the first device, and the mobile device.
